(19) United States
(12) Patent Application Publication
(10) Pub. No.: US 2007/0044891 A1
(43) Pub. Date: Mar. 1, 2007

(54) Method and device for forming non-woven, dry-laid, creped material

(75) Inventor: William Sellars, Milwaukee, WI (US)

Correspondence Address: MICHAEL BEST & FRIEDRICH, LLP, 100 E WISCONSIN AVENUE, MILWAUKEE, WI, 53202, US

(73) Assignee: Sellars Absorbent Materials, Inc., Milwaukee, WI (US)

(21) Appl. No.: 11/514,695

(22) Filed: Sep. 1, 2006

Related U.S. Application Data
(60) Provisional application No. 60/713,406, filed on Sep. 1, 2005.
(60) Provisional application No. 60/716,583, filed on Sep. 12, 2005.

(51) Int. Cl. D04H 3/02; B31F 1/12

(52) U.S. Cl. 156/62.2; 264/103; 264/282; 264/136

(57) ABSTRACT

A method of forming a fibrous material includes creating a mixture of pulp, liquid, and a debonder. Drying the mixture produces pulp, which is generally mixed with binder fibers, where each binder fiber has a core and an outer layer. The core has a first melting temperature and the outer layer has a second melting temperature lower than the first melting temperature. The method includes providing the pulp and binder fibers to a dry-lay machine to form a layer of base fibrous material. In one embodiment, the layer of base fibrous material is heated to at least partially melt the binder fibers' outer layers. The method includes applying a bonding material to the layer; creping the layer; and curing the layer to form the fibrous material. Alternatively, the method includes embossing the layer of base fibrous material; and spraying a chemical bonder to the layer of base fibrous material.

### RELATED APPLICATIONS

This application claims the benefit of U.S. Provisional Patent Application No. 60/713,406; filed on Sep. 1, 2005, and U.S. Provisional Application No. 60/716,583; filed on Sep. 12, 2005.

### BACKGROUND

Embodiments of the invention relate to non-woven material that can be used to make various products, such as paper towels, tissue paper, wipers, napkins, and the like as well as methods of making such materials.

Generally, paper towels or wipers can be made using either a wet-laid or wet-forming process, variations of wet forming known as single recreping and double recreping, or a dry-laid, air-laid, or dry-forming process.

Wet laying or forming includes creating a slurry of water and pulp. The slurry is formed into a web on a paper-making machine. Single recreping (“SRC”) includes impregnating a wet-formed sheet of paper with binder and creping one its surfaces. Double recreping (“DRC”) includes impregnating a wet-formed sheet of paper with binder and creping both of its surfaces. Dry laying or forming includes applying fibers to a mesh table or conveyor with a vacuum and then bonding the material to hold the fibers together.

### SUMMARY

The above processes have some shortcomings. Generally, wet-laid materials are held together by hydrogen bonds. However, since hydrogen bonds are dissolvable in water, the wet strength of wet-formed material is inherently limited. In addition, the length or size of the fibers used in wet-formed materials is limited due to the inability of most paper machines to handle relatively long fibers.

SRC and DRC provide generally acceptable end products, but are relatively expensive. This is, in part, because the first step in SRC and DRC relies on paper produced on a traditional, wet laid paper machine. Such machines are expensive to operate and maintain.

In dry-laid processes, the tensile strength of a non-woven material can be increased by applying a bonding agent, such as latex, to create a film over one or more surfaces of the material. However, applying latex in this manner often decreases softness and wipe-ability.

Accordingly, it would be desirable to have improved methods and devices for creating materials suitable for use as paper towels, wipers, and the like.

In one embodiment, the invention provides a method of forming a fibrous material. The method includes combining debonded pulp and binder fiber to create a mixture; providing the mixture to an air-carding machine to form a non-woven web; thermally-bonding the non-woven web by blowing hot air through the non-woven web to create a bonded, non-woven web; applying a chemical bonding material on one side of the bonded, non-woven web to create an intermediary product; creping the intermediary product; and curing the intermediary product. In an alternative form, debonder is adder to cellulose (or pulp) inline. The costs of implementing this form may be lower because it is sometimes cheaper to debond the pulp in-line rather than purchase pre-debonded pulp. In addition, placing the debonding process inline allows debonder levels to be adjusted while the overall process is running. In an alternative embodiment, a second creping step may be performed on the web. In addition, the bonding material can be cured by passing the web through an oven or performing a similar operation. Following curing, the web can be cooled and sent to a winder to create a roll.

In another embodiment, the invention provides a method of forming a non-woven web. The method includes dry-forming material to create a base non-woven web having a first side and a second side; bonding the base non-woven web so that it is strong enough to be printed and pressed to a dryer, but weak enough to develop bulk during creping; applying a bonding material on the first side of the base non-woven web; creping the base non-woven web; and curing the base non-woven web to form the non-woven web. The method can also include providing debonded pulp; providing a binding fiber material; combining the debonded pulp and binder fiber to create a mixture; and providing the mixture to an air laid machine to create the base non-woven web. In an alternative implementation, a second creping step may be performed on the web. In addition, the bonding material can be cured by passing the web through an oven or performing a similar operation. Following curing, the web can be cooled and sent to a winder to create a roll.

In another embodiment, the invention provides a machine for forming a non-woven sheet of material. The machine includes a dry-forming machine configured to accept a plurality of fibers and to create a sheet of fibrous material; and a bonder configured to receive the sheet of fibrous material from the dry-forming machine. In one implementation of the machine, the base non-woven web is bonded in a manner to be strong enough to be printed and pressed to a dryer, but weak enough to develop bulk during creping. The machine can also include a bonding station or bonding material applicator station configured to apply a bonding material to a surface of the sheet; and a creping dryer configured to receive the sheet from the bonding station and to crepe the sheet. The machine can also include a second creping dryer to crepe the sheet a second time, a cure oven to cure the sheet, and a cool roll to cool the sheet. The machine can also include a winder to wind the material.

Other aspects and embodiments will become apparent by consideration of the detailed description and accompanying drawings.

### BRIEF DESCRIPTION OF THE DRAWINGS

FIG. 1 is an illustration of a dry-forming machine, particularly an air-carding machine used to form a non-woven web of material.

FIG. 2 is an illustration a binder fiber.

FIG. 3 is an illustration of system in which a dry-formed, non-woven web is bonded and creped (which is shown particularly as double recreping).

FIG. 4 is a flow chart illustrating a process of creating a dry-formed, non-woven, creped material.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

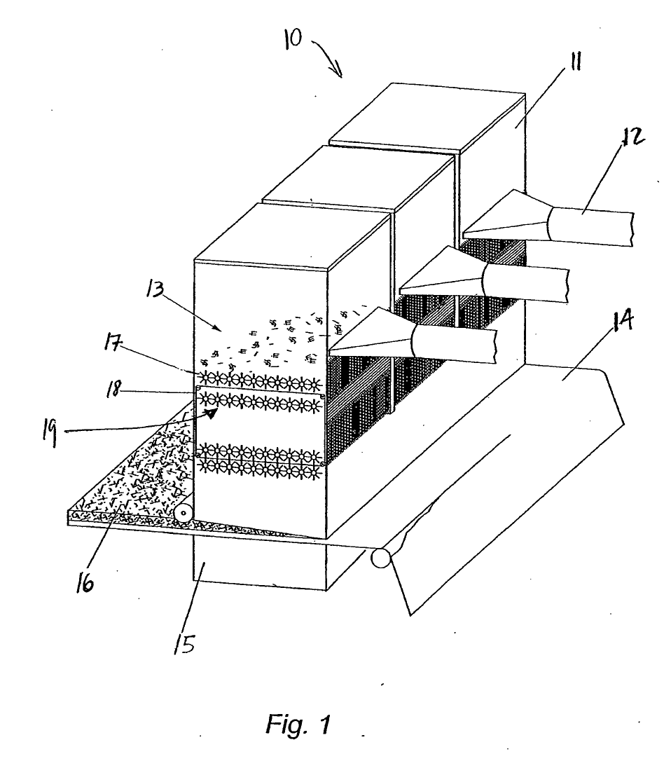

FIG. 1 illustrates an air- or dry-laid forming box or former 10. The former 10 includes a housing 11 into which fibrous material 13 is supplied from inlets 12. The forming box 10 is positioned above a conveyor table 14 onto which the fibrous material 13 is air laid. A vacuum box 15 located underneath the forming screen (e.g., the conveyor table 14) is connected to a vacuum fan that generates an air current that pulls fibrous material onto the conveyor table 14 to form a web or sheet 16 of fibrous material. The conveyor table 14 is made from a mesh material or otherwise includes a plurality of openings for concurrently allowing air to flow therethrough and retain the fibrous material 13 thereon. It is to be understood that the forming box 10 illustrated in FIG. 1 indicates only one configuration of a dry-forming machine and that other configurations may be possible.

Using dry-forming techniques, as opposed, for example, to wet-laid processes, makes it easier to produce a low-density base web or sheet 16. In addition, dry forming makes it easier to use longer fibers, such as fibers of about 2.5 cm in length. In some instances, this represents an increase of about ten times the length used in webs formed in wet-laid processes. Longer fibers help to increase the bulk and strength of a web.

The fibrous material 13 supplied through inlets 12 can include natural fibers, such as pulp or cellulose fibers, animal hair, fibers from flax, hemp, jute, ramie, sisal, cotton, kapok, glass, old newsprint, elephant grass, sphagnum, seaweed, palm fibers, or the like. Natural fibers that have been processed or modified can also be used. It is also possible to use synthetic fibers or combinations of natural, modified, and synthetic fibers. Synthetic fibers that can be used include polyamide, polyester, polyacrylic, polypropylene, bicomponent, vermiculite fibers, and others. Depending on the particular application or desired use for the end product, the fibers or combination of fibers can be selected to have absorption, softness, specified chemical reactivity, strength, and other desirable characteristics. One advantage of dry-forming is that relatively long fibers can be used to form a web. Long fibers tend to help increase the strength of a web. The fiber or fibrous material 13 can be shredded and sized prior to being provided to the inlets 12.

In one embodiment, (which for convenience is referred to as the “pulp/binder fiber embodiment”) paper or pulp fibers are used as a primary ingredient in the sheet 16. In one version of this embodiment, the pulp fibers are treated or processed prior to being dry laid. In particular, the fibers are processed using a debonder to reduce hydrogen bonding. As is known, hydrogen bonds are one type of bonding that hold paper fibers together. Reducing the amount of bonding can impact the resulting strength, elasticity, bulk thickness, and softness of paper. Other additives can be used to treat the pulp prior to the dry-laying process.

In one embodiment, dried, direct-entry recycled pulp can be used. In order to debond this pulp, debonder can be applied at a number of places in the process. For example, a liquid debonder can be applied to the pulp in a spray booth or station, an example of which is described below. After being treated with the liquid debonder, the pulp can be dried in a dryer prior to being introduced to a forming head. It is possible when using a multi-head former to introduce recycled fiber, which tends to be rough, in a centrally located head or box while introducing virgin fiber in outer heads or boxes. Mixing fibers in this way tends to increase softness.

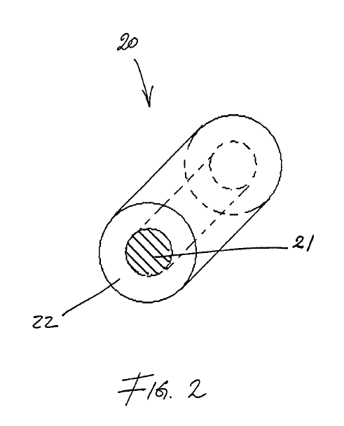

Another ingredient in the pulp/binder fiber embodiment is synthetic fiber or binder fiber. The pulp fibers can be mixed with binder fibers prior to dry laying. As the name suggests, binder fiber helps bind or hold together the other fibers in the sheet. Binder fibers can also impart certain characteristics such as elasticity and strength. An exemplary binder fiber 20 is shown in FIG. 2. The fiber 20 has a core 21 and a sheath outer layer 22. In one embodiment, the outer layer 22 has a first melting temperature and the core 21 has a second melting temperature higher than the first melting temperature. As a consequence, when the fiber 20 is heated, the outer layer 22 tends to melt before the core 21. Binder fibers comprising fibers 20 are mixed with paper fibers or cellulose. The mixture is formed into a sheet and subjected to heat. Heating the sheet causes the outer layer 22 in the fibers 20 to melt, which creates numerous thermal bonds in the sheet. Additional details of this process are set out below. Some commercially available binder fibers include sheath outer layers made of materials that tend to melt at temperatures above about 200° F.

It is possible that the fibrous material 13 can be supplied into the housing 11 in lumps. Spike rollers 17 and a belt screen 18 combined in an arrangement 19 can be included in the housing 11 to disintegrate or shred the lumps of fibrous material 13 in order to help provide a substantially even distribution of fibrous material 13 on the conveyor table 14. In the particular version illustrated, the former 10 includes two rows of spike rollers. Fibrous material 13 passes a first row of spike rollers 17, the belt screen 18, and a second row of spike rollers 17 as the fibrous material is sucked downward to the conveyor table 14 due to the vacuum 15.

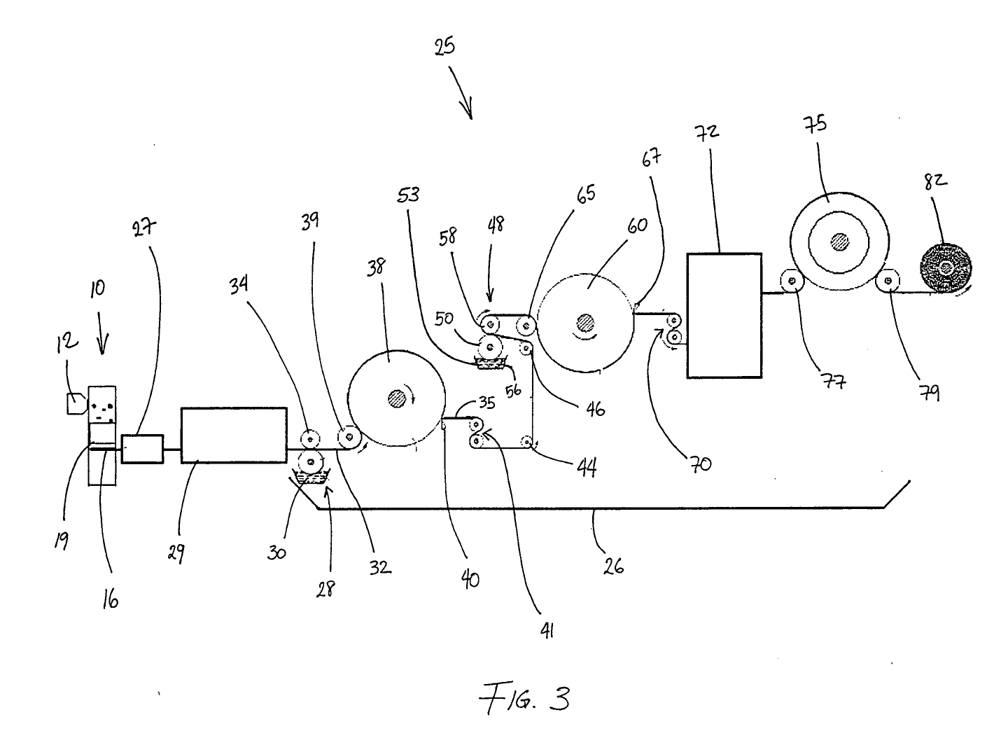

FIG. 3 illustrates a system 25 where the sheet 16 formed in the former 10 is strengthened and then delivered to a creping line 26. When initially formed on the conveyor table 14, the fibers in the sheet 16 are loosely bonded and the sheet 16 is generally not in a condition where it can be used in an end product such as paper towels or the like. In some embodiments, the sheet can be passed through spray station 27 which can be used to apply an adhesive, latex, water, or other material to the sheet. Although the station 27 is referred to as a spray station, the material can be sprayed on or applied in a mist, vapor, fog, steam, or other manner. Steam has some advantages because it helps to heat the sheet and enhance any temperature or heat curing process that occurs in subsequent steps.

In addition or in the alternative to being processed in the spray station 27, the sheet 16 can be passed through an oven 29 or similar device to heat the sheet 16. The oven 29 can be configured to force or blow hot air through the web or sheet 16. In the pulp/binder fiber embodiment, the binder fiber in the sheet melts, creating thermal bonds that connect or adhere the melted fibers with other fibers to strengthen the sheet 16. Although the spray station 27 and an oven 29 are discussed in this detailed description as one way of bonding a dry-formed sheet of material, it is possible that other techniques of strengthening a loosely-bonded, air-laid sheet can be used. For example, it is possible to spray or otherwise apply an adhesive on or to the sheet, mix UV curable material into the sheet and cure the sheet under UV light, or otherwise bond the fibers in the sheet which after being initially air laid are generally held together by the vacuum force on the former 10.

In some embodiments, the sheet 16 is bonded in the oven 29 such that it is strong enough to be printed and pressed to a dryer, but weak enough to develop bulk during creping. This can be accomplished by adding sufficient binder fiber and thermally bonding the sheet 16 to increase its tensile strength to at least about 280 grams per inch.

Once formed and bonded, the sheet 16 passes through a first bonding-material application station or rotogravure printer 28, where additional bonding material, such as liquid bonding material 30 is applied to a first side 32 of the sheet 16 in a fine pattern corresponding to a pattern in or on a roll 34. The liquid bonding material 30 can be liquid latex. A second side 35 of the sheet 16 can also be modified, as is described below. In some embodiments, the bonding material 30 is applied on the first side 32 of the sheet 16 to produce a 1-to-1 ounces per inch tensile strength ratio to base weight. In some embodiments, the base weight of the sheet 16 is from about 20 to about 200 pounds per ream (for a 3000 square foot ream). In certain embodiments, use of a printer provides an ability to adjust the depth that the bonder material penetrates the sheet 16, primarily by adjusting the depth of the groove in the printer. The ability to adjust the depth of penetration provides flexibility in manufacturing a sheet possessing desired properties. For example, less penetration usually results in greater bulk, but less strength. On the other hand, greater penetration usually increases strength, but decreases bulk. In addition to adjusting the depth of penetration, the surface area to which bonding material is applied can also be adjusted, for example, by adjusting the pattern of printing. In some embodiments, only 40 to 50 percent of the surface area of the sheet is covered with bonding material to provide desired absorbency and desirable dry wipe characteristics.

As bonding material 30 is applied to the sheet 16, the moisture content of the sheet increases. The sheet 16 is delivered or passed to a dryer or heated drum (also known as a creping or Yankee dryer) 38. The sheet 16 is pressed into adhering contact with the drum 38 by press roll 39. The bonding material 30 causes only those portions of the sheet 16 where the bonding material 30 is disposed to adhere tightly to the drum 38.

The sheet 16 is carried on the surface of the drum 38 for a distance sufficient to heat the bonding material 30 enough to tightly adhere the sheet 16 to the drum 38 and dry the sheet (or decrease its moisture content). The sheet 16 is removed from the drum 38 by a creping blade 40. As is known, the blade 40 forces the sheet 16 to change direction very quickly. During this rapid change in direction, the sheet 16 collides into the crepe blade, stops momentarily, and is folded or bent in an accordion-like manner to form a first, controlled-pattern crepe in the sheet 16.

The sheet 16 is pulled from the creping blade 40 through a pair of driven pullrolls 41 and then is advanced about turning rolls 44 and 46 to a second printer or material-application station 48. In some embodiments, the pullrolls 41 are optional, thus the sheet 16 is pulled by action of station 48, a dryer drum (discussed below), or both. The station 48 includes a first roll 50 that is positioned to draw a second bonding material 53 from a trough 56, and a pattern roll 58. In some embodiments, the station 48 is identical or substantially similar to the station 28. Likewise, the bonding material 53 can be the same as the bonding material 30. The station 48 applies bonding material on the second surface 35 of the sheet 16 in a pattern arrangement that can be the same as that of the first bonding material, although alternative patterns can be used.

After applying the second bonding material to the sheet 16, the sheet 16 is delivered to a second dryer or heated drum 60 and pressed into adhering contact with the drum 60 by press roll 65. The sheet 16 is carried on the surface of the second drum 60 for a distance and then removed by action of a second creping blade 67. The second drum 60 and the second creping blade 67 perform a second, controlled-pattern creping operation on or to the sheet 16.

The sheet 16 is then pulled from the creping blade 67 with a second set of driven pullrolls 70 and then advanced to a curing station 72. In some embodiments, the pullrolls 70 are optional and the sheet 16 is advanced directly from the creping blade 67 to the curing station 72 by the action of components in the curing station or subsequent components. The sheet 16 is heated in the curing station to a temperature that is sufficient to cure the bonding material 30 and 56. In one embodiment, the sheet is heated to a temperature of about 380° F. The sheet 16 is then moved to a large cooling roll 75 to lower the temperature of the sheet. The sheet is pressed against the large cooling roll 75 by rolls 77 and 79. The sheet is then wound into a roll (often referred to as a parent roll) 82.

In some embodiments, the sheet 16 is processed prior to delivering it to the creping line 26. In particular, running the dry-forming machine or former 10 at a higher speed than the speed of the creping line 26 can create a facsimile of creping in the sheet 16. This pre-processing can, among other things, increase the absorbency of the end product.

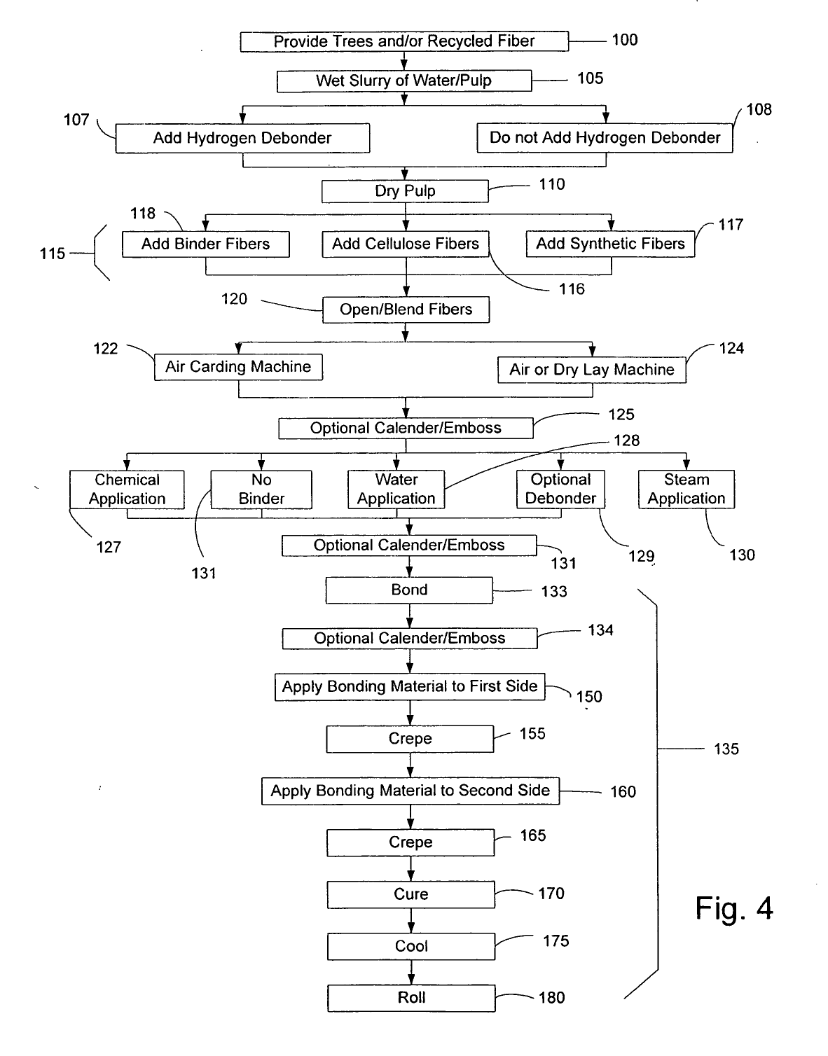

FIG. 4 is a flow chart illustrating processes of forming a non-woven web of fibrous material to achieve desired characteristics, such as strength, bulk thickness, flexibility, and the like. The process in FIG. 4 starts by obtaining raw materials from trees, recycled materials, or other sources of fiber (step 100). In step 105, a slurry is formed and hydrogen bonds are created between the fibers. Additives can be added to the slurry if desired. Step 107 illustrates the addition of debonder and step 108 illustrates that in certain instances no debonder is added or necessary. If step 107 is followed, debonded pulp or fibers are produced. As should be apparent, debonder may be applied to cellusose, fiber, or pulp in at least three ways: 1) as it is made in the pulp process, 2) using a spray booth and dryer as it is processed in the fiber preparation portion of an air-laid line prior to being introduced to the forming head; and 3) sprayed on the web after being formed by/in the forming head, but prior to the web being processed in an oven.

Water in the slurry is allowed to evaporate (i.e., the slurry is dried) and dry pulp is created, in step 110. Other fibers can be added to the pulp created in step 110, as is shown in step 115. These fibers can include fibers such as cellulose (step 116), synthetic fibers (step 117), binder fibers (step 118) or combinations thereof. As noted above, in one embodiment, binder fiber plays an important role.

The combination of fibers is blended or processed in a manner that is referred to as opening the fiber, as shown in step 120. The blended or opened fibers are provided to a dry-forming machine, which can include a dry-carding machine (step 122) or dry-laid or forming machine (step 124). The dry-forming machine forms the fibers into a web. The web can be calendered (to adjust thickness, for example) or embossed (to, for example, impart a pattern on the web), if desired, as shown in step 125. A binder or binding agent such as a chemical (step 127), water (step 128), debonder (step 129), or steam (step 130) can be added to the web formed in the dry-forming machine (at prior steps 120 or 122), but such a binder is not required and need not be used, as shown in step 131. The sheet is then bonded or cured in an oven or other device (step 133). For example, in one instance if a chemical binder is added, the bonding in step 133 corresponds to the type of chemical binder added. However, if binder fiber is added in step 118, but no binder is added in step 131, then an oven is used to melt the binder fiber in step 133. Optionally, step 133 can be modified by introducing steam into the curing process. For example, steam can be introduced into an oven. Embossing and calendering can also be performed (step 134) after the curing step 133.

As should be apparent to one of ordinary skill in the art upon review of FIG. 4 numerous other combinations are possible. In one of the possible combinations, a dry-laid web or sheet is bonded only with hydrogen bonds. It is also possible to create a web by utilizing binder fibers, chemical binding agents, and water or steam, individually or in combination. However, in many embodiments, regardless of the bonding agent or technique used, it is desirable, as noted above, to form the base non-woven web so that it is strong enough to be printed and pressed to a dryer, but weak enough to develop bulk during creping.

Once the sheet is bonded in step 133 it is delivered to a creping process (step 135). The creping process 135 includes the steps discussed above with respect to FIG. 3 and the creping line 26. A first side of the sheet is printed with a chemical bonding material, such as latex, in a predetermined pattern (at step 150). The amount of bonding material and the pattern printed on the first side of the layer are generally controlled to provide the layer with specific characteristics. The sheet is then creped (step 155). If desired, the second side of the sheet is treated with a bonding material (step 160) and a second or double creping can be performed (step 165). The bonding material is then cured (step 170). The sheet is cooled (step 175) and then rolled on a drum to create a parent roll (step 180).

It is believed that most embodiments of the invention and products produced thereby display the positive attributes of products produced by wet-laid, double recreping processes with the added benefit of increased strength due to the ability to use longer fibers. However, the disadvantages of wet-laid forming are reduced because dry-forming processes are used instead wet-laid processes. In addition, increased costs in raw materials due to the use of binder fiber and the like are believed to be offset by the elimination of the wet-laid processes. Combining dry-forming processes with creping processes as described in some embodiments herein is also believed to have advantages over certain dry-forming processes, particularly chemical-bonded, dry-forming processes in which adhesives and the like are applied to create films on the surface of dry-laid webs of material. Debonder-treated cellulose may also be used to create a soft, cloth-like product.

In addition, at least one embodiment offers a relatively large amount of flexibility. For example, a dry-formed base sheet suitable for subsequent creping can be bonded using binder fiber, water, or steam. In addition, certain embodiments provide increased strength, absorbency, bulk, and desirable hand feel. Strength is increased due to printing a pattern of adhesive on the base web and controlling the depth of the binder plus the use of longer fibers. Absorbency is enhanced in contrast to traditional air-laid materials because, in contrast to using a film of adhesive that covers the entire base web, adhesive is printed upon the web so that it covers, in some embodiments, only about 30 to about 50 percent of the surface of the web. Bulk is increased by the creping process carried out in some embodiments, and desirable hand feel or softness is achieved due to limiting the surface area upon which adhesive is printed or applied. Certain embodiments have advantages over wet-laid processes due to lower equipment costs, operation costs, labor costs, utility costs, and water requirements as compared to wet-laid techniques. In addition, wet strength and bulk are generally enhanced as compared to webs produced using wet-laid processes. Generally, the creping processes described herein exhibit decreased cost, increased bulk, and increased strength as compared to wet-laid creping processes due, at least in part, to the use of longer fibers and less binder. Finally, in some embodiments the air-laying processes have advantages over air-carding processes because longer fiber may be used.

What is claimed is:

1. A method of forming a fibrous material, the method comprising:
mixing cellulose pulp and binder fibers to create a mixture;
providing the mixture to a dry-lay machine to form a base non-woven web;
bonding the base non-woven web;
applying a bonding material to the base non-woven web;
creping the base non-woven web; and
curing the base non-woven web to form the fibrous material.

2. The method of claim 1, further comprising mixing pulp with water and a debonder to create a second mixture; and
drying the second mixture to form debonded pulp, and wherein the step of mixing cellulose pulp and binder fibers together to create a mixture includes mixing debonded pulp and binder fibers.

3. The method of claim 1, wherein bonding the base non-woven web includes spraying a chemical bonder onto the base non-woven web.

4. The method of claim 1, wherein mixing pulp and binder fibers includes providing binder fibers having a core with a first melting temperature, and an outer layer with a second melting temperature lower than the first melting temperature.

5. The method of claim 4, wherein bonding the base non-woven web includes blowing hot air through the base non-woven web; and
at least partially melting at least some of the binder fibers' outer layers.

6. The method of claim 1, further comprising
shredding and sizing cellulose pulp to form sized pulp;
applying liquid debonder to the sized pulp to form debonder treated pulp; and
drying the debonder treated pulp to form dried pulp, wherein the step of mixing cellulose pulp and binder fibers together to create a mixture includes mixing the dried pulp and binder fibers.

7. The method of claim 1, wherein applying the bonding material includes providing a pair of rolls, at least one of the pair of rolls including a plurality of grooves;
supplying the bonding material to the grooves;
feeding the base non-woven web to the pair of rolls; and
laying the bonding material to a first side of the base non-woven web.

8. The method of claim 7, further comprising applying a second bonding material to a second side of the base non-woven web.

9. The method of claim 8, wherein applying the second bonding material includes providing a second pair of rolls, at least one of the pair of rolls including a plurality of grooves;
supplying the second bonding material to the grooves;
feeding the base non-woven web to the second pair of rolls; and
laying the second bonding material to a second side of the base non-woven web.

10. A method of forming a non-woven web, the method comprising:
dry forming material to create a base non-woven web;
bonding the base non-woven web to create a bonded web that it is strong enough to be printed and pressed to a dryer but weak enough to develop bulk during creping;
applying a bonding agent to a first side of the bonded web to create a bonding-agent-treated web;
creping the bonding-agent-treated web to form a creped web; and
curing the creped web to form the non-woven web.

11. The method of claim 10, wherein dry forming the material includes
mixing pulp and binder fibers to create a mixture; and
providing the mixture to a dry-lay machine to form the base non-woven web.

12. The method of claim 11, further comprising
mixing pulp with water and a debonder to create a second mixture; and
drying the second mixture to create debonded pulp, and wherein mixing pulp and binder fibers to create a mixture includes mixing the debonded pulp and binder fibers.

13. The method of claim 11, wherein each binder fiber includes a core with a first melting temperature, and an outer layer with a second melting temperature lower than the first melting temperature.

14. The method of claim 11, wherein the dry-lay machine is an air-carding machine.

15. The method of claim 11, wherein bonding the base non-woven web includes heating the base non-woven web from a first temperature to a second temperature higher than the first temperature to at least partially melt the binder fibers' outer layers.

16. The method of claim 10, wherein applying a bonding material includes
providing a pair of rolls, at least one of the pair of rolls including a plurality of grooves;
supplying the bonding material to the grooves;
feeding the bonded web to the pair of rolls; and
laying the bonding material from the grooves to a first side of the bonded web.

17. The method of claim 10, wherein curing the creped web includes increasing the temperature of the creped web to a temperature sufficient to cure the bonding material to form a non-woven web; and
subsequently cooling the non-woven web.

18. The method of claim 10, further comprising applying a second bonding material to a second side of the non-woven web.

19. A method of forming a non-woven web, the method comprising:
dry forming material to create a base non-woven web having a first side and a second side;
bonding the base non-woven web to increase its tensile strength to at least about 10 ounces per inch;
applying a bonding material to the first side of the base non-woven web;
creping the base non-woven web; and
curing the base non-woven web to form the non-woven web.

20. The method of claim 19, wherein dry forming the material includes
mixing pulp and binder fibers to create a mixture; and
providing the mixture to a dry-lay machine to form the base non-woven web.

21. The method of claim 20, further comprising
mixing pulp with water and a debonder to create a second mixture; and
drying the second mixture.

22. The method of claim 20, wherein each binder fiber includes a core with a first melting temperature, and an outer layer with a second melting temperature lower than the first melting temperature.

23. The method of claim 20, wherein the dry-lay machine is an air-carding machine.

24. The method of claim 19, wherein curing the base non-woven web includes
increasing the temperature of the base non-woven web to about 380° F.; and
subsequently cooling the non-woven web.

25. A method of forming a fibrous material, the method comprising:
creating a mixture of pulp and liquid;
adding a debonder to the mixture;
drying the mixture to produce pulp;
mixing pulp and binder fibers, each binder fiber having a core and an outer layer, wherein the core has a first melting temperature and the outer layer has a second melting temperature lower than the first melting temperature;
providing the pulp and binder fibers to a dry-lay machine to form a layer of base fibrous material;
heating the layer of base fibrous material to at least partially melt the binder fibers' outer layers to form a bonded web;
applying a first bonding material to a first side of the bonded web to form a bonding-material-treated web;
creping the bonding-material-treated web to form a creped web;
applying a second bonding material to a second side of the creped web to form a doubly-bonding-material-treated web;
creping the doubly-bonding-material-treated web to form a doubly-creped web;
curing the doubly-creped web; and
cooling the doubly-creped web to created a cooled web.

26. The method of claim 25, further comprising rolling the cooled web to create a parent roll.

27. The method of claim 25, wherein applying a first bonding material to a first side of the bonded web includes spraying a chemical bonder onto the bonded web.

28. The method of claim 25, wherein the dry-lay machine is an air-carding machine.

29. The method of claim 25, wherein curing the doubly-creped web includes heating the doubly-creped web to a temperature sufficient to cure the first and second bonding materials.

30. A machine for forming a non-woven sheet of material, the machine comprising:
a dry forming machine configured to accept a plurality of fibers and create a sheet of fibrous material;
a bonder configured to receive the sheet of fibrous material from the dry forming machine and bond the fibrous material;
a bonding station configured to apply a bonding material to a surface of the sheet; and
a creping dryer configured to receive the sheet from the bonding station and to crepe the sheet.

31. The machine of claim 30, further comprising a second bonding station configured to apply a second bonding material to a second side of the sheet.

32. The machine of claim 31, further comprising a second creping dryer configured to receive the sheet of fibrous material from the second bonding station and to crepe the sheet.

33. The machine of claim 30, further comprising a curing station configured to receive the sheet of fibrous material at a first temperature and heat the sheet to a second temperature higher than the first temperature.

34. The machine of claim 33, wherein the second temperature is about 380° F.

35. The machine of claim 34, further comprising a cooling roll configured to receive the sheet from the curing station at about the second temperature and cool the sheet to a third temperature lower than the second temperature.

36. The machine of claim 35, further comprising a spraying station configured to apply a material to the sheet of fibrous material.

37. The machine of claim 36, further comprising an embosser.
